(19) United States
(12) Patent Application Publication
(10) Pub. No.: US 2019/0034605 A1
(43) Pub. Date: Jan. 31, 2019

(54) AUTHENTICATION METHOD OF SPECIFIED CONDITION, AUTHENTICATION SOFTWARE OF SPECIFIED CONDITION, DEVICE AND SERVER USED FOR EXECUTING AUTHENTICATION OF SPECIFIED CONDITION

(71) Applicants: Otto Wang, Taipei (TW); Mou-Yen Chen, Taipei (TW)

(72) Inventors: Otto Wang, Taipei (TW); Mou-Yen Chen, Taipei (TW)

(21) Appl. No.: 15/824,016

(22) Filed: Nov. 28, 2017

(30) Foreign Application Priority Data
Jul. 25, 2017 (TW) 106124914

(51) Int. Cl. G06F 21/32; H04L 29/06; G06K 7/14

(52) U.S. Cl. CPC G06F 21/32; G06N 5/047; G06K 7/1413; H04L 63/0884

(57) ABSTRACT

An authentication method of a specified condition for executing authentication of the specified condition for a user through a device is provided. The authentication method includes the following steps: actuating a first capturing unit of the device to capture an information to be authenticated of the user; actuating the first capturing unit or a second capturing unit of the device to capture a specified condition information; and executing an analysis judgment software to analyze and judge whether the information to be authenticated is consistent with the specified condition information or not, if consistent, the user being authenticated to reach the specified condition, thereby overcoming the problem of the prior art that needs troublesome manual steps for authentication.

### FIELD OF THE INVENTION

The present invention relates to an authentication means for authenticating a user meeting a specified condition by comparison and analysis, and more particularly to an authentication method, an authentication software, a device and a server used for authentication to complete the authentication by using a mobile device.

### BACKGROUND OF THE INVENTION

In recent years, with the development of science and technology, many procedures that need people to the relevant authority personally can be handled via Internet to save time for a user, or many software or applications powered by an electronic device (such as a smartphone) need the authentication of a specified condition for subsequent application. In order to confirm whether the operator performing the network operation is the user of the procedure or confirm that the user meets the specified condition, the user usually needs to hold a specified certificate (for example, a citizen digital certificate or a digital certificate) applied in advance, a specified action performed in advance, a specified scene, or a specific procedure completed in advance and the permission of the person at the site in order to achieve the authentication of the specified condition. However, the specified certificate, the specified action, the specified scene, or a specific tag needs to be applied in advance before the user to execute the authentication of the specified condition, or the person at the site has to confirm the operation. It is inconvenient for the user to execute the authentication of the specified condition in the conventional method, and this method is not cost-effective.

### SUMMARY OF THE INVENTION

The primary object of the present invention is to provide an authentication method of a specified condition, an authentication software of the specified condition, a device and a server used for executing authentication of the specified condition. Two contents are compared with a preset content or compared with each other to execute the authentication of the specified condition for a user.

According to one aspect of the present invention, an authentication method of a specified condition for executing authentication of the specified condition for a user through a device is provided. The authentication method comprises the following steps: actuating a first capturing unit of the device to capture an information to be authenticated of the user; actuating the first capturing unit or a second capturing unit of the device to capture a specified condition information; and executing an analysis judgment software to analyze and judge whether the information to be authenticated is consistent with the specified condition information or not, if consistent, the user being authenticated to reach the specified condition.

According to another aspect of the present invention, an authentication software of a specified condition, installed to a device and used for executing authentication of the specified condition for a user is provided. The authentication software executes the following commands: a first capturing command, actuating a first capturing unit of the device to capture an information to be authenticated of the user; a second capturing command, actuating the first capturing unit or a second capturing unit of the device to capture a specified condition information; and an analysis judgment command, analyzing and judging whether the information to be authenticated is consistent with the specified condition information or not, if consistent, the user being authenticated to reach the specified condition.

According to a further aspect of the present invention, a device used for authentication of a specified condition is provided. The device is installed with the aforesaid authentication software to execute the authentication of the specified condition for a user.

A server for executing the authentication of the specified condition is used to execute the following contents: an authentication data reception page is opened to actuate and receive an image captured by a capturing device in the device used by the user; an identification unit of the specified condition is executed to analyze the obtained image. Two face features and a text content are analyzed to determine whether the face features, fingerprint features, or image features are the same person, as well as through the text content to obtain relevant identity data, or through the text content to the corresponding database to obtain the stored photo (for example, through the credit card number to communicate with the database to search for the stored image photo or text data of the cardholder), or to obtain an action, a scene or a tag in the image, and then analyze and judge whether the action, scene or tag is consistent with a specified action, a specified scene or a specified tag. Finally, an execution result notification is performed. The comparison result is displayed or transmitted to a specified location.

In an embodiment of the present invention, the authentication method further comprises the steps of: using the device to execute the analysis judgment software for analyzing and judging whether the information to be authenticated is consistent with the specified condition information or not and for getting an analysis judgment result; and actuating an Internet unit of the device and uploading the analysis judgment result to a server or another software via the Internet unit.

In an embodiment of the present invention, the authentication method further comprises the steps of: actuating an Internet unit of the device and uploading the information to be authenticated and the specified condition information to a server via the Internet unit, and using the server to execute the analysis judgment software for analyzing and judging whether the information to be authenticated is consistent with the specified condition information or not and for getting an analysis judgment result.

In an embodiment of the present invention, the authentication method further comprises the steps of: returning the analysis judgment result obtained by the server to the device via the Internet unit.

In an embodiment of the present invention, the first capturing unit includes a front camera, and the second capturing unit includes a rear camera, a location detection unit, or a gyroscope.

In an embodiment of the present invention, the step of capturing the information to be authenticated comprises capturing a face information or an action information or a scene information of the user.

In an embodiment of the present invention, the step of capturing the specified condition information comprises capturing a face photograph disclosed in a document of the user, and the authentication of the specified condition is to authenticate the identity of the user.

In an embodiment of the present invention, the device further communicates with a reading unit, and the step of capturing the specified condition information further comprises reading visible or invisible information recorded in the document through the reading unit.

In an embodiment of the present invention, the reading unit includes a near field communication unit, and the document includes a near field communication tag so that the document is read by the reading unit.

In an embodiment of the present invention, the step of capturing the document comprises capturing a text datum disclosed in the document to authenticate the identity of the user or through the text datum to another database to search for a corresponding photo or document so as to complete the authentication.

In an embodiment of the present invention, the step of capturing the specified condition information comprises capturing a selfie face image that is stored in the device and appears commonly, and the authentication of the specified condition is to authenticate the user whether is the owner of the device.

In an embodiment of the present invention, the step of capturing the specified condition information comprises capturing a scene in which the user is located, and the authentication of the specified condition is to authenticate whether the scene in which the user is located is a specified scene.

In an embodiment of the present invention, the step of capturing the specified condition information comprises capturing an action performed by the user, and the authentication of the specified condition is to authenticate whether the action performed by the user is a specified action.

In an embodiment of the present invention, the step of capturing the specified condition information comprises capturing a tag held by the user, and the authentication of the specified condition is to authenticate whether the tag held by the user is a specified tag. Wherein, the tag is a visible image, an invisible image, or a barcode.

In an embodiment of the present invention, in the step of actuating the first capturing unit or the second capturing unit, the first capturing unit or the second capturing unit captures a positioning signal. Wherein, the positioning signal may be a GPS positioning signal, a communication base station signal, a geomagnetic positioning signal, or a terrain image identification signal.

In an embodiment of the present invention, the authentication software further comprises an upload command. Wherein, the analysis judgment command comprises using the device to execute an analysis judgment software for analyzing and judging whether the information to be authenticated is consistent with the specified condition information or not and for getting an analysis judgment result. The upload command actuates an Internet unit of the device and uploads the analysis judgment result to a server or another software via the Internet unit.

In an embodiment of the present invention, the authentication software further comprises an upload command. Wherein, the upload command actuates an Internet unit of the device and uploads the information to be authenticated and the specified condition information to a server via the Internet unit. The analysis judgment command comprises using the server to execute an analysis judgment software for analyzing and judging whether the information to be authenticated is consistent with the specified condition information or not and for getting an analysis judgment result.

In an embodiment of the present invention, the authentication software further comprises an upload command. The upload command returns the analysis judgment result obtained by the server to the device via the Internet unit.

In an embodiment of the present invention, the first capturing command comprises capturing a face information or an action information of the user.

In an embodiment of the present invention, the second capturing command comprises capturing a face photograph disclosed in a document of the user, and the authentication of the specified condition is to authenticate the identity of the user.

In an embodiment of the present invention, the device further communicates with a reading unit, and the second capturing command comprises reading information recorded in the document or displaying a corresponding barcode image through the reading unit.

In an embodiment of the present invention, the second capturing command comprises capturing a text datum disclosed in the document to authenticate the identity of the user.

In an embodiment of the present invention, the second capturing command comprises capturing a selfie face image that is stored in the device and appears commonly; and the authentication of the specified condition is to authenticate the user whether is the owner of the device.

In an embodiment of the present invention, the second capturing command comprises capturing a scene in which the user is located, and the authentication of the specified condition is to authenticate whether the scene in which the user is located is a specified scene.

In an embodiment of the present invention, the second capturing command comprises capturing an action performed by the user, and the authentication of the specified condition is to authenticate whether the action performed by the user is a specified action.

In an embodiment of the present invention, the second capturing command comprises capturing a tag held by the user, and the authentication of the specified condition is to authenticate whether the tag held by the user is a specified tag.

In an embodiment of the present invention, the first capturing command or the second capturing command captures a positioning signal.

Accordingly, the authentication method of the specified condition, the authentication software of the specified condition, the device and the server for executing the authentication of the specified condition provided by the present invention is used to analyze and judge whether the information to be authenticated is consistent with and the specified condition information (such as, the user's document, the face image stored in the device used by the user, the scene, address or house number in which the user is located, the action performed by the user, or the tag held by the user) to achieve the purpose of the authentication of the specified condition. It is also possible to obtain the information to be authenticated and the specified condition information at the same time by setting. The authentication of the specified condition may be applied to the subsequent procedure through the server. It is not necessary to use the prior certificate for authentication in the overall procedure. The authentication method of the specified condition, the authentication software of the specified condition, the device and the server for executing the authentication of the specified condition of the present invention uses a simply method to execute the authentication of the specified condition for the user. The efficiency of the authentication of the specified condition is substantially enhanced on the basis of the accuracy of the authentication of the specified condition.

### BRIEF DESCRIPTION OF THE DRAWINGS

FIG. 1 is a flow chart of an authentication method of a specified condition in accordance with an embodiment of the present invention;

FIG. 1A is a flow chart of an authentication method of a specified condition in accordance with another embodiment of the present invention;

FIG. 2 is a schematic view of an authentication software of a specified condition in accordance with an embodiment of the present invention;

FIG. 2A is a schematic view of an authentication software of a specified condition in accordance with another embodiment of the present invention;

FIG. 2B is a schematic view of an authentication software of a specified condition in accordance with a further embodiment of the present invention;

FIG. 3 is a schematic view of a device employing the authentication method of the specified condition of FIG. 1 and the authentication software of the specified condition of FIG. 2; and

FIG. 4 is a schematic view showing the execution process of a server in accordance with an embodiment of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

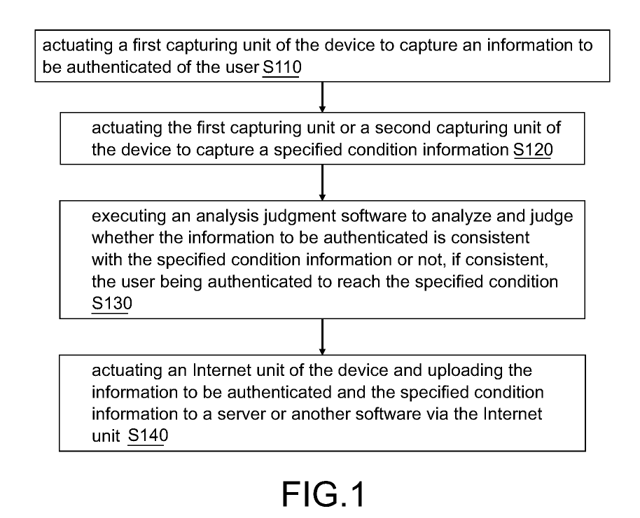

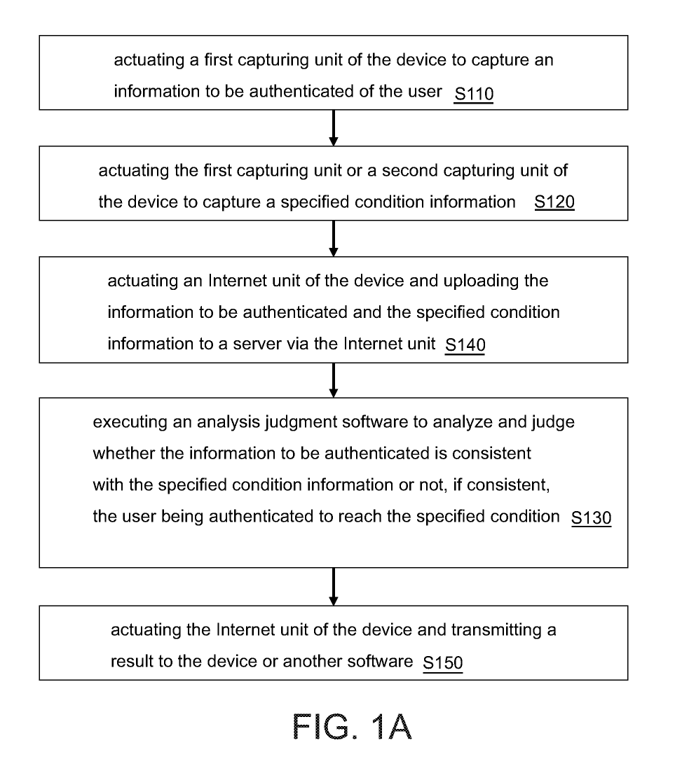

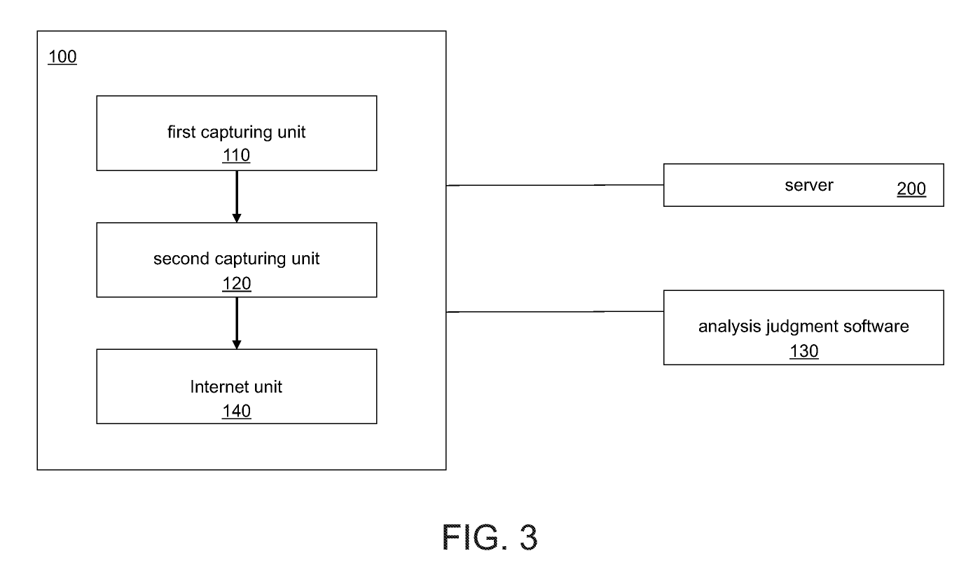

As shown in FIG. 1 and FIG. 3, in an embodiment, an authentication method of a specified condition is adapted for executing authentication of the specified condition for a user through a device 100. The authentication method comprises the following steps: in step S110, a first capturing unit 110 of the device 100 is actuated to capture information to be authenticated of the user. In step S120, the first capturing unit 110 or a second capturing unit 120 of the device 100 is actuated to capture specified condition information (for example, the user's document or the content disclosed in the document). Wherein, the first capturing unit 110 or the second capturing unit 120 may be required to simultaneously capture the information to be authenticated and the specified condition information, which means the following two situations: (1) one of the first capturing unit 110 and the second capturing unit 120 is actuated to capture the information to be authenticated and the specified condition information (2) the first capturing unit 110 and the second capturing unit 120 are simultaneously actuated, the first capturing unit 110 captures the information to be authenticated, meanwhile, the second capturing unit 120 captures the specified condition information to ensure the user's operation in person. In step 130, analysis judgment software 130 is executed to analyze and judge whether the information to be authenticated and the specified condition information are consistent or not. If consistent, the user is authenticated to reach the specified condition. In addition, the authentication information and the specified condition can be transmitted or stored by using data encryption technology, packet technology, or blockchain technology. Furthermore, the device system for analyzing and judging may also be a server or an artificial intelligence system, and the artificial intelligence system may randomly indicate movements of users to identify if it matches the requirement.

FIG. 1A shows another embodiment of the authentication method of the present invention. The information to be authenticated and the specified condition information are first transmitted to a server (step S140). After the analysis judgment is completed (step S130), the result is transmitted to the device 100 or transmitted to another software as the key to actuate the next step.

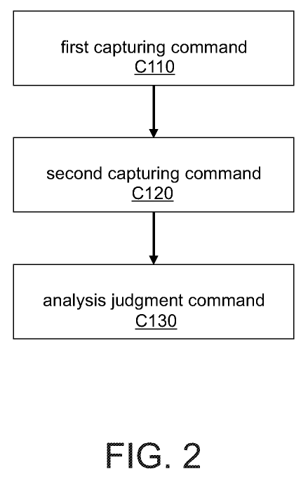

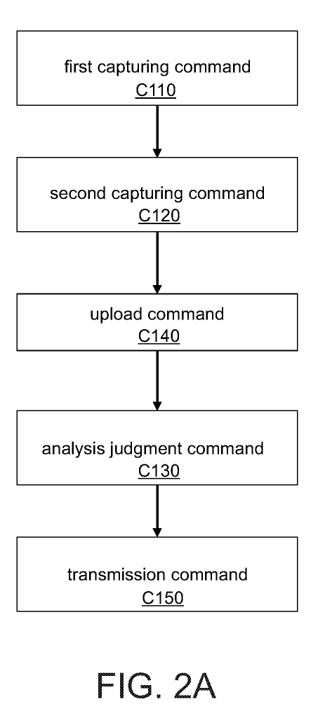

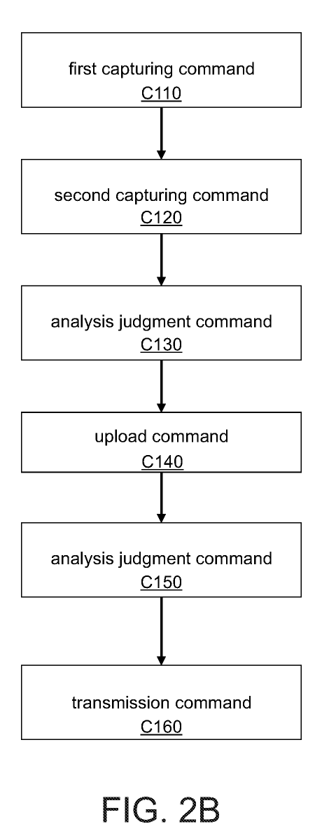

Similarly, in this embodiment, the authentication software of the specified condition may be installed to the device 100 to execute the authentication of the specified condition for the user, including the execution of a first capturing command C110, a second capturing command C120, and an analysis judgment command C130 (as shown in FIG. 2).

The first capturing command C110: the first capturing unit 110 of the device 100 is actuated to capture the information to be authenticated.

The second capturing command C120: the first capturing unit 110 or the second capturing unit 120 of the device 100 is actuated to capture the specified condition information (e.g., what is disclosed in the user's document). The image captured by the first capturing unit 110 is set to simultaneously obtain the information to be authenticated and the specified condition information. The approach includes that the image shows a frame at a predetermined position for the user to execute registration and for the device to judge whether it can be captured simultaneously.

The analysis judgment command C130 is used to analyze and judge whether the information to be authenticated is consistent with the specified condition information or not. If consistent, the user is authenticated to reach the specified condition. In other words, the authentication method of the specified condition of this embodiment and the authentication software of the specified condition have the same technical means to achieve the purpose of the authentication of the specified condition, but the present invention is not limited thereto. Embodiments of each step or each command are described hereinafter. Further, the user device 100 may execute the analysis judgment directly, or the information to be authenticated and the specified condition information may be transmitted to a server as shown in FIG. 2A for analysis. Further, as shown in FIG. 2B, after the analysis judgment is completed by the user device 100, the analysis result of the information to be authenticated and the specified condition information are uploaded to the server (step C140), and the server executes the analysis or depth-in analysis (step C150) to enhance the correctness of the authentication. After completing the authentication, the command is transmitted back to the device 100 or to designated software (step C160). The initial operation is executed by the user device 100 (step C130) so that the workload of the server can be reduced.

First, in this embodiment, the device 100 may be a mobile device (such as a tablet computer, a smartphone). Preferably, the device 100 has a first capturing unit 110 and a second capturing unit 120. Wherein, the first capturing unit 110 may be a front camera, and the second capturing unit 120 may be a rear camera, a location detection unit, or a gyroscope, but not limited thereto. Further, the first capturing unit 110 and the second capturing unit 120 may be an external device, such as a 360-degree viewfinder, a 3D camera, or a lens capable of reading a specified spectrum, connected by means of a wired signal connection or a wireless signal connection. Thus, in step S110 (in the software, the first capturing command C110), the first capturing unit 110 of the device 100 is actuated to capture the information to be authenticated. Wherein, the step of capturing the information to be authenticated (i.e., the step S110; in the software, the first capturing command C110) includes capturing the face information or action information of the user. For example, the front camera as the first capturing unit 110 is used to shoot the user's face, and it may shoot or record a video to capture the user's static posture or dynamic action.

Similarly, in step S120 (in the software, the second capturing command C120), the first capturing unit 110 or the second capturing unit 120 of the device 100 is actuated to capture specified condition information. First, the content disclosed in the user's document is described as one embodiment of the specified condition information, and the authentication of the specified condition is to authenticate the identity of the user. The document includes one of an identification document, a health insurance card, or a driver license of the user, in which the user's face photograph and the related text content are recognized, but not limited thereto. Wherein, the step of capturing the specified condition information (i.e., the step S120; in the software, the second capturing command C120) includes capturing the face photograph disclosed in the user's document. For example, the front camera as the first capturing unit 110 is used to capture the face photograph in the document, or the rear camera as the second capturing unit 120 is used to capture the face photograph in the document.

The step of capturing the document (i.e., step S120; in the software, the second capturing command C120) may further include capturing the text data disclosed in the document (e.g., the user's name, date of birth, address, etc.) or a password (visible password or invisible image or invisible password) to further authenticate the user's identity in subsequent steps. The present invention doesn't limit whether to capture the text or not, it can be adjusted according to needs. For example, the text content is captured to compare with the corresponding specified condition in the designated database. Furthermore, the step S110 and the step S120 may be set to be actuated simultaneously. In this way, the subsequent step or command is to analyze and judge whether the information to be authenticated (the user's face information) is consistent with the specified condition information (the face photograph or the text data disclosed in the document) or not, thereby authenticating the user's identity (that is, to authenticate whether the user reaches the specified condition). The photograph in the document is compared with the image captured by the first capturing command by means of a full face image comparison, a specific organ image feature comparison, an iris image comparison, or other pre-set conditions.

In the step of actuating the first capturing unit 110 or the second capturing unit 120 (i.e., in step S110 and step S120; in the software, the first capturing command C110 and the second capturing command C120), the first capturing unit or the second capturing unit also captures a positioning signal to further obtain the information of the user's location. This information may also be used for subsequent authentication. Wherein, the positioning signal may be a signal or an image of a GPS (Global Positioning Satellite System), a signal base station of a communication device, or a triangulation positioning system, alternatively, the second capturing unit is a gyroscope to read the path of rotation or turning of the device as a specified condition. In addition, a video may be used as a specified condition. The action or the scene in the video is analyzed to judge whether the specified condition is completed or not. However, the present invention is not limited thereto, and it may be adjusted according to demand.

In addition, in a further embodiment, when the document has the information to be further read through a reading unit, the device 100 may communicate with a reading unit (not shown). The step of capturing the specified condition information (i.e., step S120; in the software, the second capturing command C120) further includes reading the information recorded in the document through the reading unit, such as general text data, hidden text data that is invisible to the naked eye, or electronic data read by a radio frequency identification (RFID) unit. Taking a document with a near field communication (NFC) tag as an example, the reading unit may be a near field communication unit to read the information stored in the tag through the reading unit, such as text information and image information. The reading unit may be used to read a barcode image in the document to obtain the information disclosed in the document. However, the present invention does not limit the type of the document and the manner of reading, which can be adjusted according to the actual demand. The reading unit may be used in cooperation with the original unit in the device, for example, the barcode image is captured by the image capturing unit and then interpreted by the internal program.

In addition to the authentication of the user's identity, the above-mentioned authentication method and the authentication software may use other types of specified conditions.

For example, a plurality of face images stored in the device 100 or a selfie face image that appears commonly is described as an embodiment of the specified condition information. The authentication of the specified condition is to authenticate the user whether is the owner of the device 100. In the step of capturing the specified condition information (i.e., the step S120; in the software, the second capturing command C120) includes capturing the face image that is stored in the device 100 and appears commonly. For example, the user uses the other software to search the face image that is stored in the device 100 and appears commonly, and uses capturing software as the second capturing unit 120 to capture a representative image. Furthermore, the step S110 and the step S120 may be set to be actuated simultaneously. In this way, the subsequent step or command is to analyze and judge whether or not the information to be authenticated (the user's face information) is consistent with the specified condition information (the face image that is stored in the device 100 and appears commonly), thereby authenticating the user whether is the owner of the device 100 (that is, authenticating whether the user reaches the specified condition). Furthermore, it may be communicated and compared with the photo or other information of the social network account (for example, Facebook, Instagram, and the like) linked by the device 100, in the same way, the photo that appears commonly or is used in a profile can be used as an object for comparison.

Similarly, the scene in which the user is located is described as an embodiment of the specified condition information, and the authentication of the specified condition is to authenticate whether or not the scene in which the user is located is the specified scene. Wherein, the step of capturing the specified condition information (i.e., the step S120; in the software, the second capturing command C120) includes capturing a scene in which the user is located. For example, the front camera as the first capturing unit 110 is used to photograph the scene, or the rear camera as the second capturing unit 120 is used to photograph the scene. Furthermore, the step S110 and the step S120 may be set to be actuated simultaneously. In this way, the subsequent step or command is to analyze and judge whether or not the information to be authenticated (the user's face information) is consistent with the specified condition information (the scene in which the user is located), thereby authenticating whether the scene in which the user is located is the specified scene (that is, authenticating whether the user reaches the specified condition).

Further, the action performed by the user is described as one embodiment of the specified condition information. The authentication of the specified condition is to authenticate whether or not the action performed by the user is a specified action. Wherein, the step of capturing the specified condition information (i.e., the step S120; in the software, the second capturing command C120) includes capturing an action performed by the user. For example, the front camera as the first capturing unit 110 is used to capture the action, or the rear camera as the second capturing unit 120 is used to capture the action. Besides, capturing the action performed by the user may capture a static posture (image) or a dynamic action (video) of the user. Furthermore, the step S110 and the step S120 may be set to be actuated simultaneously. In this way, the subsequent step or command is to analyze and judge whether or not the information to be authenticated (the user's face information) is consistent with the specified condition information (the action performed by the user), thereby authenticating whether the action performed by the user is the specified action (that is, authenticating whether the user reaches the specified condition).

Besides, the tag held by the user is described as one embodiment of the specified condition information. The authentication of the specified condition is to authenticate whether or not the tag held by the user is a specified tag. Wherein, the step of capturing the specified condition information (i.e., the step S120; in the software, the second capturing command C120) includes capturing a tag held by the user. For example, the front camera as the first capturing unit 110 is used to photograph the tag held by the user, or the rear camera as the second capturing unit 120 is used to photograph the tag held by the user. The tag may be an image picture, a two-dimensional barcode or an image barcode on an article held by a user, but the present invention does not limit the type and the means of implementation. Furthermore, the step S110 and the step S120 may be set to be actuated simultaneously. In this way, the subsequent step or command is to analyze and judge whether or not the information to be authenticated (the user's face information) is consistent with the specified condition information (the tag held by the user), thereby authenticating whether the tag held by the user is the specified tag (that is, authenticating whether the user reaches the specified condition).

Through the above-mentioned two steps or two commands, the information to be authenticated (such as, the user's face information) and the specified condition information (e.g., the content disclosed in the user's document, the face image that appears commonly in the device used by the user (such as the sefile face image), the scene in which the user is located, the action performed by the user, or the tag held by the user) can be obtained. Therefore, in step 130 (in the software, the analysis judgment command C130), the analysis judgment software 130 is executed to analyze and judge whether the information to be authenticated is consistent with the specified condition information. If consistent, the user is authenticated to reach the specified condition. The steps of analyzing and judging the information to be authenticated and the content are described below as two embodiments. It is emphasized that the condition information described in step S120 is not limited to capturing an image, and it may be information other than an image, such as capturing location information or capturing the information of the memory in the device.

The analysis judgment software 130 (i.e., the analysis judgment command C130 in the software) used in step 130 may be installed in the device 100. That is, the analysis judgment step (i.e., the step S130; in the software, the analysis judgment command C130) of the authentication method of the specified condition further includes: the analysis judgment software 130 is executed by the device 100 to analyze and judge whether or not the information to be authenticated is consistent with the specified condition information and get the analysis judgment result. Next, the authentication method of the specified condition further includes the step S140 (i.e., the upload step, the upload command C140 is included in the software).

In the upload step or upload command, Internet unit 140 of the device 100 is actuated, and the analysis judgment result is uploaded via the Internet unit 140 to the server 200 or another software (not shown). It can be seen that the authentication method of the specified condition or the authentication software of the specified condition directly executes the analysis judgment software 130 on the device 100 to analyze and judge whether the information to be authenticated is consistent with the specified condition information or not. If consistent, the user is authenticated to reach the specified condition, and the analysis judgment result is uploaded to the server 200 which needs the analysis judgment result of the specified condition to execute the subsequent step or transmitted to another software or another server for execute the subsequent step.

In addition, the analysis judgment software 130 (i.e., the analysis judgment command C130 in the software) used in step 130 may be installed in the server 200. That is, the authentication method of the specified condition further includes the step S140 (i.e., the upload step; in the software, the upload command C140): the Internet unit 140 of the device 100 is actuated, and the information to be authenticated and the specified condition information are uploaded to the server 200.

Next, in the analysis judgment step (i.e., the step S130; in the software, the analysis judgment command C130), the analysis judgment software 130 is executed via the server 200 to analyze and judge whether or not the information to be authenticated is consistent with the specified condition information and get the analysis judgment result.

It is understood that the authentication software of the specified condition or the authentication software of the specified condition uploads the two data to be analyzed and judged to the server 200, and then the analysis judgment software 130 is executed by the server 200 to analyze and judge whether the information to be authenticated is consistent with the specified condition information or not. If consistent, the user is authenticated to reach the specified condition, and the authentication result of the specified condition can be directly applied to the server 200 for subsequent steps. Alternatively, the authentication method of the specified condition further includes a return step (the authentication software of the specified condition further includes a return command. The analysis judgment result obtained by the analysis judgment step or the analysis judgment command at the server 200 is returned back to the device 100 via the Internet unit 140 to be transmitted to another software or another server for subsequent use.

As described above, the execution order of the foregoing step S130 (i.e., the analysis judgment step; in the software, the analysis judgment command C130) and the step S140 (i.e., the upload step; in the software, the upload command C140) can be exchanged. The present invention is not limited to when the analysis judgment step or the analysis judgment command is executed.

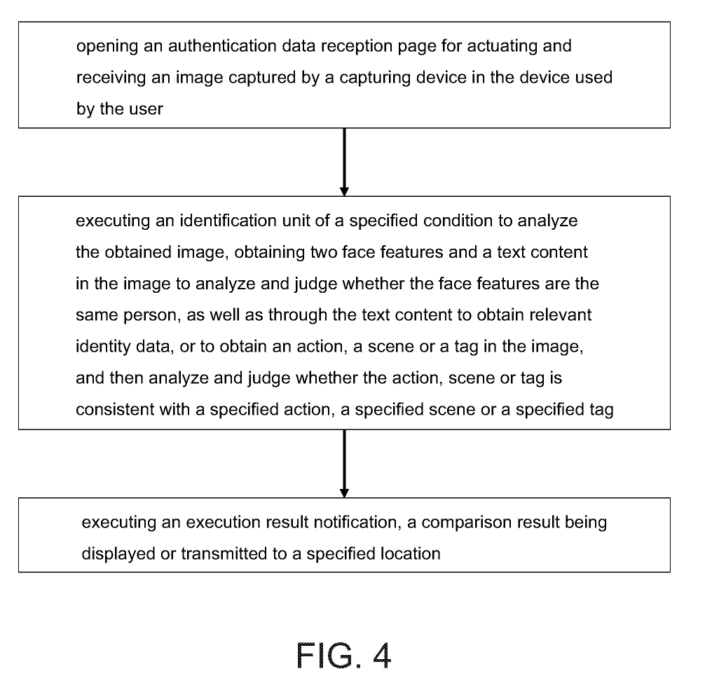

Furthermore, FIG. 4 is a schematic diagram of an execution process of a server according to an embodiment of the present invention. Referring to FIG. 4, in this embodiment, the server 200 for executing the authentication of the specified condition is used to execute the following contents: an authentication data reception page is opened to actuate and receive an image (e.g., the user's face information of the information to be authenticated, the face photograph or the text content disclosed in the document as the specified condition information, the face image that appears commonly in the device used by the user, the scene in which the user is located, the action performed by the user, or the tag held by the user) captured by an image capturing device (e.g., the first capturing unit 110 or the second capturing unit 120 or the reading unit (not shown) or the capturing software (not shown) in the device 100 used by the user. Next, the identification unit (for example, the analysis judgment software 130) of the specified condition executes the analysis according to the obtained image. Two face features and a text content are analyzed to determine whether the face features are the same person, as well as through the text content to obtain relevant identity data, or to obtain an action, a scene or a tag in the image, and then analyze whether the action, scene or tag is consistent with a specified action, a specified scene or a specified tag. Finally, an execution result notification is performed. The comparison result is displayed or transmitted to a specified location (e.g., displayed on the server 200, or transmitted to another software or another server for subsequent use).

In addition, the present invention can further set the information to be authenticated and the specified condition to be analyzed or judged by capturing the surrounding sound or the content of the specified language as the basis for judgment.

Thereby, through the authentication method of the specified condition, the authentication software of the specified condition, the device 100 installed with the authentication software of the specified condition for executing the authentication of the specified condition, and the server for executing the authentication of the specified condition, the user can use an own device 100 (e.g., a mobile device, a laptop, a portable computer, a tablet PC, a personal computer, a vehicle computer, or a traffic recorder, but not limited to these devices) to cooperate with the document held by the user, the existing face image stored in the device, the action performed by the user, the scene in which the user is located, or the tag held by the user. A simply method is performed by the device 100 or the server 200 for the purpose of quickly achieving the authentication of the specified condition, and the subsequent relevant procedure after the authentication of the specified condition is performed by the server 200, another software, or another server. It is not necessary to use the prior certificate for authentication in the overall procedure. The device may employ a device 100 not owned by the user, such as a ATM, a kiosk, a access control device, a handheld device, etc.

Accordingly, the authentication method of the specified condition, the authentication software of the specified condition, the device and the server for executing the authentication of the specified condition provided by the present invention is used to analyze and judge whether the information to be authenticated which is captured by the first capturing unit or the second capturing unit of the device is consistent with and the specified condition information (such as, the user's document, the face image stored in the device used by the user, the scene in which the user is located, the action performed by the user, or the tag held by the user) to achieve the purpose of the authentication of the specified condition. It is also possible to obtain the information to be authenticated and the specified condition information at the same time by setting. The subsequent relevant procedure after the authentication of the specified condition may be executed by the server, or the authentication result is transmitted to another software or server for executing the subsequent relevant procedure after the authentication of the specified condition. It is not necessary to use the prior certificate for authentication in the overall procedure. The authentication method of the specified condition, the authentication software of the specified condition, the device and the server for executing the authentication of the specified condition of the present invention uses a simply method to execute the authentication of the specified condition for the user. The efficiency of the authentication of the specified condition is substantially enhanced on the basis of the accuracy of the authentication of the specified condition.

Although particular embodiments of the present invention have been described in detail for purposes of illustration, various modifications and enhancements may be made without departing from the spirit and scope of the present invention. Accordingly, the present invention is not to be limited except as by the appended claims.

1. An authentication method of a specified condition, adapted for executing authentication of the specified condition for a user through a device, comprising the following steps:
actuating a first capturing unit of the device to capture an information to be authenticated of the user;
actuating the first capturing unit or a second capturing unit of the device to capture a specified condition information; and
executing an analysis judgment software to analyze and judge whether the information to be authenticated is consistent with the specified condition information or not, if consistent, the user being authenticated to reach the specified condition.

2. The authentication method as claimed in claim 1, further comprising the steps of:
using the device to execute the analysis judgment software for analyzing and judging whether the information to be authenticated is consistent with the specified condition information or not and for getting an analysis judgment result; and
actuating an Internet unit of the device and uploading the analysis judgment result to a server or another software via the Internet unit.

3. The authentication method as claimed in claim 1, further comprising the steps of:
actuating an Internet unit of the device and uploading the information to be authenticated and the specified condition information to a server via the Internet unit, and
using the server to execute the analysis judgment software for analyzing and judging whether the information to be authenticated is consistent with the specified condition information or not and for returning an analysis judgment result to the device.

4. The authentication method as claimed in claim 1, wherein the step of capturing the information to be authenticated comprises capturing a face information or an action information of the user; wherein the step of capturing the specified condition information comprises capturing a face photograph disclosed in a document of the user, and the authentication of the specified condition is to authenticate the identity of the user.

5. The authentication method as claimed in claim 4, wherein the device further communicates with a reading unit, and the step of capturing the specified condition information further comprises reading information or a corresponding barcode image recorded in the document through the reading unit.

6. The authentication method as claimed in claim 4, wherein the step of capturing the document comprises capturing a text datum disclosed in the document.

7. The authentication method as claimed in claim 1, wherein the step of capturing the specified condition information comprises capturing a selfie face image that is stored in the device and appears commonly, the authentication of the specified condition is to authenticate the user whether is the owner of the device; or the step of capturing the specified condition information comprises capturing a scene in which the user is located, the authentication of the specified condition is to authenticate whether the scene in which the user is located is a specified scene; or the step of capturing the specified condition information comprises capturing an action performed by the user, the authentication of the specified condition is to authenticate whether the action performed by the user is a specified action; or the step of capturing the specified condition information comprises capturing a tag held by the user, the authentication of the specified condition is to authenticate whether the tag held by the user is a specified tag.

8. The authentication method as claimed in claim 1, wherein in the step of actuating the first capturing unit or the second capturing unit, the first capturing unit or the second capturing unit captures a positioning signal.

9. An authentication software of a specified condition, installed to a device and used for executing authentication of the specified condition for a user, executing the following commands:
a first capturing command, actuating a first capturing unit of the device to capture an information to be authenticated of the user;
a second capturing command, actuating the first capturing unit or a second capturing unit of the device to capture a specified condition information; and
an analysis judgment command, analyzing and judging whether the information to be authenticated is consistent with the specified condition information or not, if consistent, the user being authenticated to reach the specified condition.

10. The authentication software as claimed in claim 9, further comprising an upload command, wherein the analysis judgment command comprises using the device to execute an analysis judgment software for analyzing and judging whether the information to be authenticated is consistent with the specified condition information or not and for getting an analysis judgment result; wherein the upload command actuates an Internet unit of the device and uploads the analysis judgment result to a server or another software via the Internet unit.

11. The authentication software as claimed in claim 9, further comprising an upload command, wherein the upload command actuates an Internet unit of the device and uploads the information to be authenticated and the specified condition information to a server via the Internet unit; wherein the analysis judgment command comprises using the server to execute an analysis judgment software for analyzing and judging whether the information to be authenticated is consistent with the specified condition information or not and for returning an analysis judgment result to the device.

12. The authentication software as claimed in claim 9, wherein the first capturing command comprises capturing a face information or an action information of the user.

13. The authentication software as claimed in claim 9, wherein the second capturing command comprises capturing a face photograph disclosed in a document of the user, and the authentication of the specified condition is to authenticate the identity of the user.

14. The authentication software as claimed in claim 13, wherein the device further communicates with a reading unit, and the second capturing command further comprises reading information recorded in the document or displaying a corresponding barcode image through the reading unit.

15. The authentication software as claimed in claim 13, wherein the second capturing command further comprises capturing a text datum disclosed in the document.

16. The authentication software as claimed in claim 9, wherein the second capturing command comprises capturing a selfie face image that is stored in the device and appears commonly; or capturing a scene in which the user is located, the authentication of the specified condition is to authenticate whether the scene in which the user is located is a specified scene; or capturing an action performed by the user, the authentication of the specified condition is to authenticate whether the action performed by the user is a specified action; or capturing a tag held by the user, the authentication of the specified condition is to authenticate whether the tag held by the user is a specified tag.

17. The authentication software as claimed in claim 9, wherein the first capturing command or the second capturing command captures a positioning signal.

18. A device used for authentication of a specified condition, installed with the authentication software as claimed in claim 9 to execute the authentication of the specified condition for a user.
